(19) United States
(12) Patent Application Publication
(10) Pub. No.: US 2009/0024795 A1
(43) Pub. Date: Jan. 22, 2009

(54) METHOD AND APPARATUS FOR CACHING DATA

(76) Inventor: Makoto KOBARA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/174,817

(22) Filed: Jul. 17, 2008

(30) Foreign Application Priority Data
Jul. 20, 2007 (JP) 2007-189850

(51) Int. Cl. G06F 12/08; G06F 12/00

(52) U.S. Cl. 711/118; 711/216; 711/E12.018; 711/E12.017; 711/E12.001

(57) ABSTRACT

A relay unit inputs data and an index. A cache management unit determines whether or not a space area to cache data exists. In the case where there is a space area, the cache management unit caches data. An identifier generating unit generates an identifier corresponding to contents of the cached data. The identifier is registered in a cache data table in association with the data. The identifier is registered in a cache index table in association with the index. In the case where there is no space area, the cache management unit secures a space area. The cache management unit unregisters an identifier associated with the data which was cached in the secured area.

### CROSS-REFERENCE TO RELATED APPLICATIONS

This application is based upon and claims the benefit of priority from prior Japanese Patent Application No. 2007-189850, filed Jul. 20, 2007, the entire contents of which are incorporated herein by reference.

### BACKGROUND OF THE INVENTION

1. Field of the Invention

The present invention is related to a cache method and a cache apparatus for caching data.

2. Description of the Related Art

In recent years, a WAN accelerator (WAN high-speed equipment) has become known as a device to access a distant storage device by using a line having a narrower band and larger delay in comparison to LAN (Local Area Network), such as an Internet.

This WAN accelerator performs delay control, transfer data compression and caching in, for example, a TCP/IP layer or an application layer such as an NFS (Network File System)/CIFS (Common Internet File System)/iSCSI (Internet Small Computer Systems Interface).

Not exclusive to this WAN accelerator, the size of a memory area used for caching is limited. Here, for example, suppose a case where data which is in the storage device connected to a WAN accelerator via, for instance, an internet is cached in the WAN accelerator. In this case, generally, the size of memory area used for caching in the WAN accelerator is smaller than that of the memory area (for example, disk volume) in the storage device.

Therefore, it is important to consider how to perform caching control effectively in the limited memory area. Accordingly, a cache control method such as LRU (Least Recent Used) which focuses on temporal locality or spatial locality is being considered.

Meanwhile, there is disclosed a technique (referred hereinafter as prior art) which, in a case where data having identical contents (referred hereinafter as identical data) but different index (for example, address or file name) is already registered in the cache, points the identical data which is already cached, instead of caching the data in another area (for example, refer to Carl A. Waldspurger, VMware Inc. “Memory Resource Management in VMware ESX Server”, USENIX OSDI '02, (2002)). In this manner, identical data (cache data having identical contents) is shared. By sharing cache data having identical contents in this manner, it is possible to save memory area for storing cache data.

According to this prior art, to determine whether or not the contents of data are identical, a hash value of the data is obtained. A high-speed search is performed by using this hash value, and the data itself is compared subsequently.

Generally, the size of a memory area required to store a pointer for data (in other words, memory address) is significantly smaller than the size of a memory area required for storing data. Accordingly, by using the prior art mentioned above, it is possible to increase the amount of data to be cached in the limited memory area.

However, in the prior art mentioned above, in the case of nullifying less-needed cache data when, for example, the memory area for caching has exhausted, the cache data for the index pointing the identical data will simultaneously be nullified.

Further, when the identical data is cached anew after being nullified, the index which had pointed the identical data before being nullified cannot be re-registered pointing this identical data again.

For example, suppose that, in a case where identical data is cached anew after once being nullified, there is, for instance, a read request with respect to the index which had pointed the identical data before it was nullified. In this case, since this index does not point the identical data cached anew (not re-registered), it is necessary to obtain (read) the identical data from, for example, the storage device in spite of the identical data being cached already.

### BRIEF SUMMARY OF THE INVENTION

The object of the present invention is to provide a cache method and a cache apparatus which can have a plurality of indexes point data when the data pointed by the plurality of indexes is re-registered after being nullified.

According to an embodiment of the present invention, a method of caching performed by a cache apparatus comprising a cache database, a cache data table and a cache index table used to cache data is provided. This method comprises inputting data and an index indicating the data; generating an identifier corresponding to contents of the input data; determining whether or not a space area to cache the input data exits in the cache storing means; caching the input data in the cache storing means in the case where it is determined that the space area exists in the cache storing means; registering the generated identifier in the cache data table in association with the cached data; registering the generated identifier in the cache index table in association with the input index; in the case where it is determined that the area does not exist in the cache storing means, securing the space area; caching the input data in the secured space area; and unregistering an identifier registered in the cache data table in association with data which was cached in the secured area.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a hardware configuration of a relay device according to an embodiment of the present invention.

FIG. 2 is a block diagram mainly showing a functional configuration of the relay device 30 according to the present embodiment.

FIG. 3 shows an example of a data structure of a cache data table 23.

FIG. 4 shows an example of a data structure of a cache index table 24.

FIG. 5 is an illustration explaining the relation between the cache data table 23 and the cache index table 24.

FIG. 6 is a flow chart showing a processing procedure of a cache hit determination processing of the relay device 30 in the case where there is a read request from a client device 40.

FIG. 7 is a flow chart showing a flow of processing in the case where a read request is transmitted from the client device 40 to a storage device 50.

FIG. 8 is a flow chart showing a flow of processing in the case where a write request is transmitted from the client device 40 to the storage device 50.

FIG. 9 is a flow chart showing a processing procedure of a cache registration processing carried out in the relay device 30.

FIG. 10 is an illustration which specifically explains an operation of the present embodiment.

### DETAILED DESCRIPTION OF THE INVENTION

An embodiment of the present invention will be explained in reference to the drawings, as follows.

FIG. 1 is a block diagram showing a hardware configuration of a relay device (cache apparatus) according to the present embodiment. As shown in FIG. 1, a computer 10 is connected to an external memory device 20 such as, for example, a hard disk drive (HDD). This external memory device 20 stores a program 21 which is executed by the computer 10. The relay device 30 is comprised of the computer 10 and the external memory device 20.

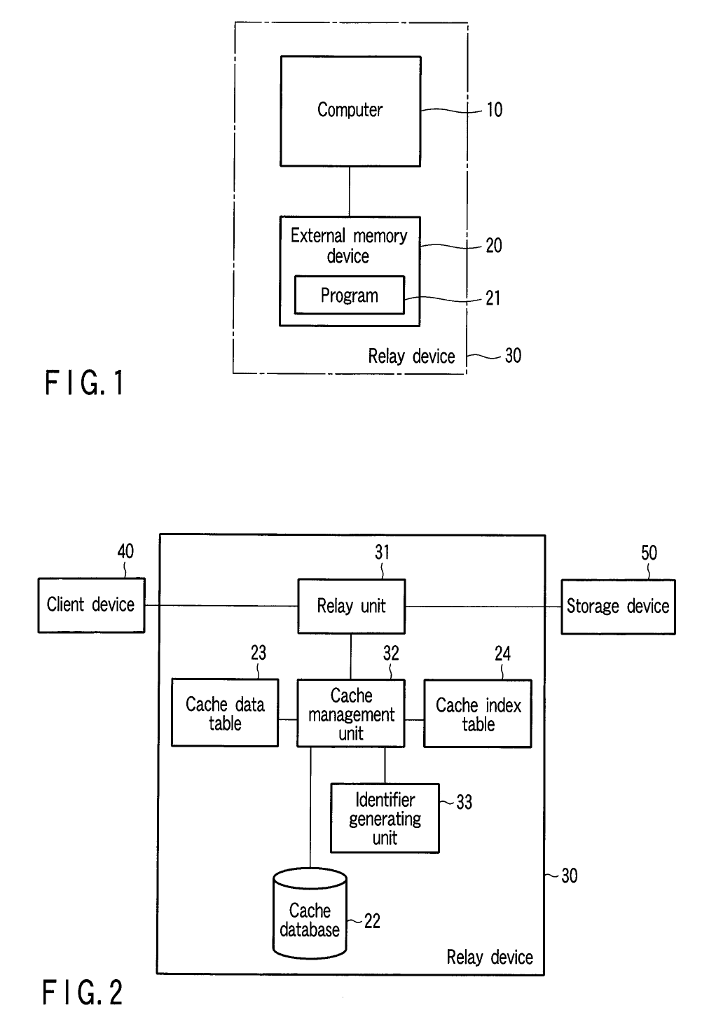

FIG. 2 is a block diagram mainly showing a functional configuration of the relay device 30 according to the present embodiment. The relay device 30 is connected to a client device (transferring destination device) 40 and a storage device (transferring source device) 50 so that it can communicate with them. For example, a communication by iSCSI (Internet Small Computer System Interface) is carried out between the relay device 30 and the client device 40. The same is carried out between the relay device 30 and the storage device 50.

The client device 40 is a device to access, for example, the storage device 50. Further, the client device 40 functions as an initiator in iSCSI (SCSI).

The storage device 50 is provided with a disk volume to store various data. The storage device 50 provides an access to the disk volume of the storage device 50 for the client device 40. The storage device 50 functions as a target in iSCSI (SCSI).

The relay device 30 relays communication between, for example, the client device 40 and the storage device 50. The relay device 30 transfers, for example, data (block volume) transmitted from the storage device 50 to the client device 40. The relay device 30 has a function to cache this transferred data. By doing so, data transfer efficiency can be improved between the client device 40 and the storage device 50.

The client device 40 attempts to connect to the storage device 50 by designating a client device 40 side interface of the relay device 30. Having accepted this, the relay device 30 connects to the storage device 50 from a storage device 50 side interface. In this manner, the connection between the client device 40 and the storage device 50 is established.

Further, the client device 40 side/storage device 50 side interfaces can physically be one interface. For example, if it is an iSCSI, it would be sufficient if an IP address or port number of TCP/IP can identify that they are different interfaces.

The relay device 30 includes a relay unit 31, a cache management unit 32 and an identifier generating unit 33. In the present embodiment, the relay unit 31, the cache management unit 32 and the identifier generating unit 33 are realized by the computer 10 shown in FIG. 1 executing the program 21 stored in the external memory device 20. This program 21 is distributable by being stored on a computer readable storage medium in advance. Further, this program 21 may be downloaded into the computer 10 via, for example, a network.

The relay device 30 also includes a cache database 22, a cache data table 23 and a cache index table 24. In the present embodiment, the cache database 22, the cache data table 23 and the cache index table 24 are stored in the external memory device 20.

The relay unit 31 relays an iSCSI-PDU between, for example, the client device 40 and the storage device 50. If this iSCSI-PDU is related to data transfer (READ&SCSIDATAIN/WRITE&DATAOUT), an access to the cache is carried out via the cache management unit 32. Meanwhile, if this ISCSI-PDU is not related to data transfer, the PDU is directly transferred to its destination by the relay unit 31.

Here, suppose, the case in which, for example, the client device 40 reads data from the storage device 50. In such case, the client device 40 transmits a read request to the relay device 30. This read request includes, for example, an index which indicates data to be the reading target. The index includes, for example, a file name of the data which is to be the reading target or an address of the data which is stored in the storage device 50 etc. The relay unit 31 inputs the read request transmitted by the client device 40. The relay unit 31 transfers the input read request to the storage device 50. The relay unit 31 inputs data read out in accordance with the transferred read request (data indicated by the index included in the read request) from the storage device 50.

Meanwhile, suppose the case in which, for example, the client device 40 writes data into the storage device 50. In such case, the client device 40 transmits a write request to the relay device 30. This write request includes, for example, data to be the target of writing and an index which indicates the data. The index includes, for example, a file name of the data to be the writing target or an address in the storage device 50 into which the data is to be written etc. The relay unit 31 inputs the write request transmitted by the client device 40. The relay unit 31 transfers the input write request to the storage device 50.

The cache management unit 32 performs cache control with respect to, for example, data which is to be the read target or data which is to be the write target (hereinafter referred to as target data). The cache management unit 32 determines whether or not there is a space area to cache the target data in the cache data base 22. In the case where there is a space area to cache the target data, the cache management unit 32 caches the target data by storing the target data in the space area of the cache data base 22. Further, in the case where there is no space area to cache the target data, the cache management unit 32 secures a space area by deleting, for example, data (cache data) stored in the cache data base 22.

The cache management unit 32 associates an identifier corresponding to the contents of the target data with the target data and registers it in the cache data table 23. Further, the cache management unit 32 associates an identifier corresponding to the contents of the target data with an index indicating the target data and registers it in the cache index table 24.

In the case where, for example, there is a read request from the client device 40, the cache management unit 32 determines if there is a cache hit in accordance with the index included in the read request. In the case of a cache hit, the data stored in the cache database 22 is sent out to the client device 40 via the relay unit 31. Meanwhile, in the case of a cache mishit, the read request is transferred to the storage device 50, and data which is assigned by the read request is read out from the storage device 50.

Further, in the case where the cache data is deleted from the cache database 22 (to secure space area), the cache management unit 32 deletes the identifier associated with the data and registered in the cache data table 23 so as to unregister the identifier.

The identifier generating unit 33 receives, for example, target data from the cache management unit 32. The identifier generating unit 33 generates an identifier which corresponds to, for example, the contents of received target data. When doing so, the identifier generating unit 33 uses a predetermined hash function such as MD5 or SHA1, to generate an identifier. In other words, the identifier generating unit 33 generates a hash value as an identifier.

The hash value (identifier) which corresponds to the contents of the target data is associated with the target data (cache data) stored (cached) in the cache database 22 and kept (registered) in the cache data table 23.

The hash value which corresponds to the contents of the target data assigned by the read request or the write request is associated with an index included in the read request or the write request mentioned above, and kept (registered) in the cache index table 24. Further, in the following explanation, an index is, for example, a combination of a serial number and a Logical Block Address (LBA) of a disk volume in which target data is read or written. The serial number is a number to identify the disk volume in the storage device 50. It can be obtained by issuing, for example, a CDB (Command Descriptor Block) inquiry from the relay device 30 to the storage device 50. Further, there are various ways to realize this, such as, in the case of iSCSI, it is possible to use a pair of iSCSI-InitiatorName and LUN as a serial number.

The cache index table 24 is prepared for each of all disk volumes which exist on the storage device 50. In other words, there is a cache index table 24 which corresponds to each of the disk volumes in the storage device 50. Further, in the case where, for example, a new disk volume is made in the storage device 50, a cache index table 24 which corresponds to such disk volume is made. For example, in the case where a hash value of data which is indicated by an index (serial number and LBA) is not generated, for example, a hash value indicating invalid (for example, values are all 0) is associated with the index and registered in the cache index table 24.

The hash value registered in the cache index table 24 is, for example, a hash value of data in units of a sector (multiplication of 512 bytes) of an LBA. As a matter of convenience, the following will be explained in a sector unit (512 bytes).

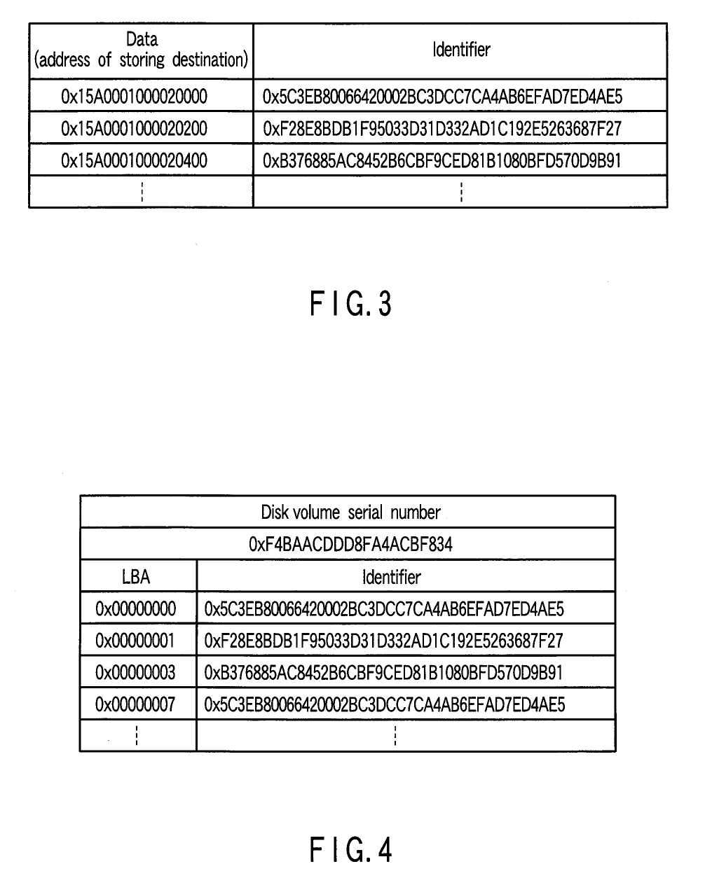

FIG. 3 shows an example of a data structure of the cache data table 23. As shown in FIG. 3, in the cache data table 23, cache data (address of storing destination) and identifiers are associated and registered. Here, the address of the cache data is the address where the cache data is stored in the cache database 22, and is, for example, described in 8 bytes. Further, the identifier is a hash value which is generated from the contents of the associated data by using a predetermined hash function (for example SHA1). Further, this hash value is described, for example, in 20 bytes.

In the example shown in FIG. 3, the hash value “0x5C3EB80066420002BC3DCC7CA4AB6EFAD7ED4AE5 (20 bytes)” is associated with the address of the cache data “0x15A0001000020000 (8 bytes)” and registered. The hash value “0xF28E8BDB1F95033D31D332AD1C192E5263687F27” is associated with the data address “0x15A0001000020200” and registered. Further, the hash value “0xB376885AC8452B6CBF9CED81B1080BFD570D9B91” is associated with the data address “0x15A0001000020400” and registered.

FIG. 4 shows an example of a data structure of the cache index table 24. As shown in FIG. 4, the serial number of a disk volume, LBA and identifier are registered in the cache index table 24. In the cache index table 24, a combination of the serial number of the disk volume and the LBA is provided as the index. Further, there is a cache index table 24 for each disk volume (serial number of disk volume).

As shown in FIG. 4, in the cache index table 24, an identifier is registered in association with each of the LBA in the disk volume which is identified by a serial number.

Here, the serial number of the disk volume is described in, for example, 10 bytes. Further, the LBA is described in 4 bytes. The identifier is a hash value which is generated from the contents of data (stored in the LBA) indicated by the serial number of the disk volume and the LBA, by using a predetermined hash function (such as, SHA1). This hash value is described in, for example, 20 bytes.

FIG. 4 shows a cache index table 24 corresponding to a disk volume identified by the serial number “0xF4BAACDDD8FA4ACBF834”. In the example shown in FIG. 4, the hash value “0x5C3EB80066420002BC3DCC7CA4AB6EFAD7ED4AE5 (20 bytes)” is associated with the LBA “0x00000000 (4 bytes)” and registered. The hash value “0xF28E8BDB1F95033D31D332AD1C192E5263687F27” is associated with the LBA “0x00000001” and registered. The hash value “0xB376885AC8452B6CBF9CED81B1080BFD570D9B91” is associated with the LBA “0x00000003” and registered. The hash value “0x5C3EB80066420002BC3DCC7CA4AB6EFAD7ED4AE5” is associated with the LBA “0x00000007” and registered.

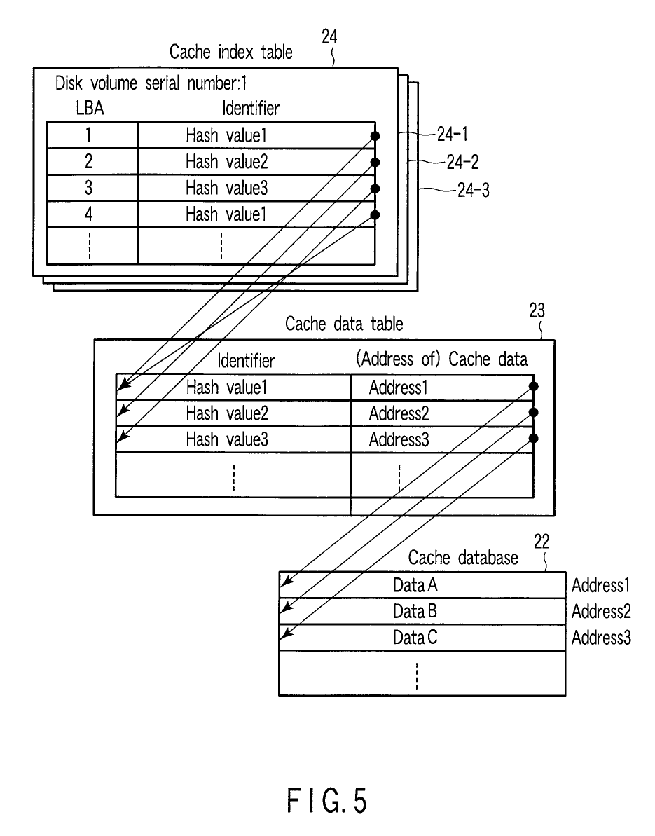

Now, the relation between the cache data table 23 and the cache index table 24 will be explained with reference to FIG. 5. Further, different from FIGS. 3 and 4 mentioned above, in FIG. 5, as a matter of convenience, the serial number of the disk volume (the disk volume serial number), LBA, identifier (hash value) and data address kept (registered) in the cache data table 23 and the cache index table 24 are simplified and described.

As shown in FIG. 5, cache index tables 24-1 to 24-3 are prepared for each of all disk volumes which exist on the storage device 50. In other words, there are the cache index tables 24-1 to 24-3 which correspond to each of the disk volumes in the storage device 50.

FIG. 5 explains the cache index table 24-1 corresponding to a disk volume in the storage device 50 which is identified by a disk volume serial number “1”. A cache index table 24-i (i=1,2, . . . ) corresponds to a disk volume in the storage device 50 which is identified by a disk volume serial number “i”.

In this cache index table 24-1, an identifier “hash value 1” is associated with LBA “1” and registered. Further, an identifier “hash value 2” is associated with LBA “2”, an identifier “hash value 3” is associated with LBA “3”, and an identifier “hash value 1” is associated with LBA “4” and registered. In other words, the data stored in LBA “1” and the data stored in LBA “4” are identical data. That is, LBA “1” and LBA “4” are in the state of pointing the same data.

Meanwhile, in the cache data table 23, “address 1” is associated with the identifier “hash value 1” and registered as a cache data address. Further, “address 2” is associated with the identifier “hash value 2” and “address 3” is associated with the identifier “hash value 3”, and are registered as cache data addresses.

Further, in “address 1” of the cache database 22, Data A is stored. In “address 2” of the cache database 22, Data B is stored. In “address 3” of the cache database 22, Data C is stored.

Data A is data which is cached in “address 1” of the cache database 22 and is (identical to) the data stored in LBA “1” and LBA “4” of the disk volume serial number “1” of the storage device 50.

Data B is data cached in “address 2” of the cache database 22 and is (identical to) the data stored in LBA “2” of the disk volume serial number “1” of the storage device 50.

Data C is data cached in “address 3” of the cache database 22 and is (identical to) the data stored in LBA “3” of the disk volume serial number “1” of the storage device 50.

As mentioned above, the cache data table 23 and the cache index table 24-1 are associated by the identifier (hash value). Accordingly, in the case where there is a read request from, for example, the client device 40 to the storage device 50, the relay device 30 can identify the cache data stored in the cache database 22 from the index (disk volume serial number and LBA) included in the read request.

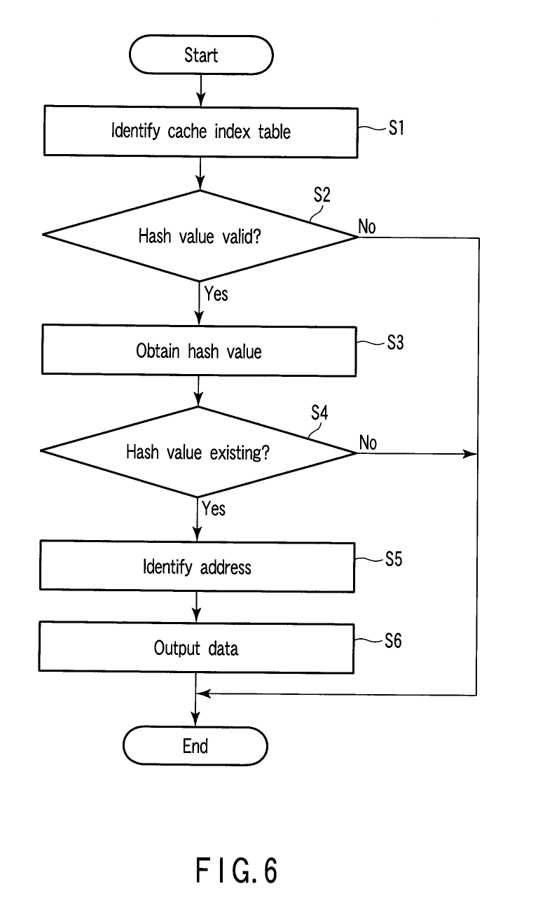

Now, the processing procedure of cache hit determination processing performed by the relay device 30 in the case where there is, for example, a read request from the client device 40 will be explained in reference to the flow chart of FIG. 6. The read request transmitted from the client device 40 includes an index indicating data (to become the read target) assigned by the read request. This index includes a disk volume serial number which identifies the disk volume in the storage device 50 in which data assigned by the read request is stored, and an LBA in the disk volume.

Firstly, the relay unit 31 in the relay device 30 inputs (receives) a read request transmitted from the client device 40. The relay unit 31 passes the input read request over to the cache management unit 32.

Then, the cache management unit 32 identifies the cache index table 24-i which corresponds to the disk volume identified by the disk volume serial number (the disk volume serial number “i”) included in the read request passed over from the relay section 31 (step S1).

In the identified cache index table 24-i, the cache management unit 32 identifies the hash value registered in association with the LBA included in the read request. The cache management unit 32 determines whether or not the identified hash value is valid (step S2).

In the case where, for example, the hash value of the data assigned by the read request is not generated as mentioned above, a hash value indicating invalid (for example, values are all 0) is registered in association with the LBA in which the data is stored.

That is, in the case where the identified hash value is not a hash value indicating invalid, the cache management unit 32 determines the hash value as valid.

In the case where the identified hash value is determined as valid (YES in step S2), the cache management unit 32 obtains the hash value (step S3).

The cache management unit 32 determines whether or not the obtained hash value exists in the cache data table 23 (step S4).

In the case where the obtained hash value is determined as existing in the cache data table 23 (YES in step S4), the cache management unit 32 identifies the address of the cache data registered in association with the hash value in the cache data table 23 (step S5).

The cache management unit 32 obtains data (cache data) stored (cached) in the identified address with reference to the cache database 22. The cache management unit 32 outputs (transmits) the obtained data to the client device 40 via the relay unit 31 (step S6).

For example, in the case where a read request is transmitted from the client device 40 to the storage device 50, as mentioned above, the processing to determine whether or not the data assigned by the read request is cached in the cache database 22 (cache hit determination) is performed.

Meanwhile, in the case where the identified hash value is determined as invalid in step S2, the data assigned by the read request is considered as not cached, i.e., as a cache mishit, and the processing is ended.

Further, in the case where the obtained hash value is determined as not existing in the cache data table 23 in step S4, it is considered as a cache mishit and the processing is ended.

Now, the processing procedure to register data (i.e., cache data) in the cache database 22 of the relay device 30 will be explained as follows. The timing in which data registration processing is carried out in this cache database 22 (hereinafter, referred to as cache registration processing) is different depending on, for example, whether the request from the client device 40 to the storage device 50 is a read request or a write request.

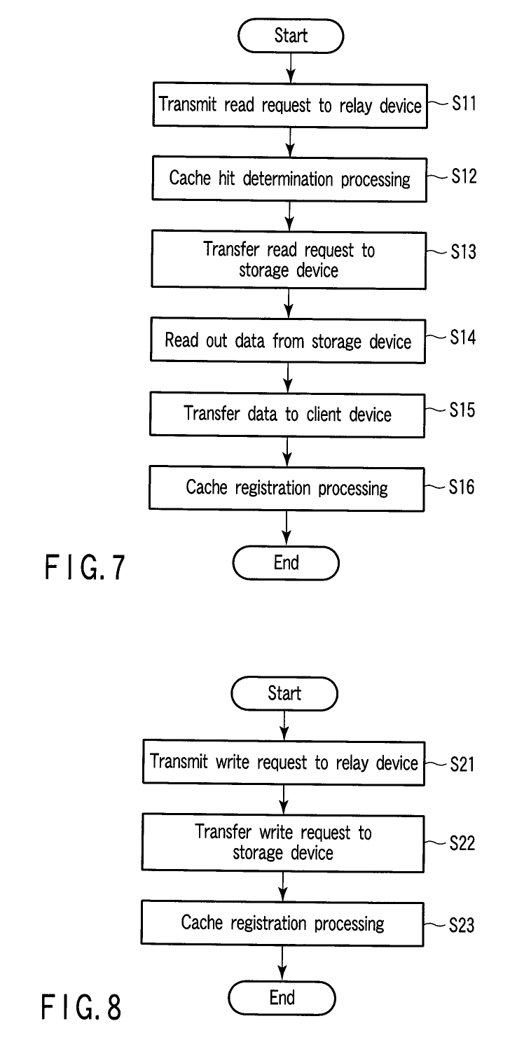

Here, with reference to the flow chart of FIG. 7, the flow of processing in the case which, for example, a read request is transmitted from the client device 40 to the storage device 50 will be explained.

First of all, the client device 40 transmits a read request to the relay device 30 (step S11).

The read request transmitted by the client device 40 is input to the relay device 30. Here, the relay device 30 performs a cache hit determination processing as shown in FIG. 6 mentioned above (step S12).

Here, suppose the case in which the cache hit determination processing performed by the relay device 30 determines a cache mishit. In this case, the relay device 30 transfers the read request to the storage device 50 (step S13). In the case where it is determined as a cache hit, the relay device 30 transmits the cache data to the client device 40, and the processing is ended.

In the storage device 50, the data (read data) assigned by the read request transferred by the relay device 30 is read out (step S14). The storage device 50 transmits the read out data to the relay device 30.

The relay device 30 transfers the data transmitted by the storage device 50 to the client device 40 (step S15).

The relay device 30 performs the cache registration processing (hereinafter, referred to as a first cache registration processing) to the data transmitted by the storage device 50 (step S16).

Now, with reference to the flow chart of FIG. 8, the flow of processing in the case which, for example, a write request is transmitted from the client device 40 to the storage device 50 will be explained. The write request includes data which is assigned by the write request (write data) and an index indicating the data. This index includes a disk volume serial number which identifies the disk volume in the storage device 50 in which, for example, the write data is to be written, and an LBA of the disk volume.

First of all, the client device 40 transmits a write request to the relay device 30 (step S21).

The write request transmitted by the client device 40 is input to the relay device 30. The relay device 30 transfers the input write request to the storage device 30 (step S22). When the write request is transferred by the relay device 30, the storage device 50 performs write processing of data in accordance with the write request.

Meanwhile, in the relay device 30, a cache registration processing (hereinafter, referred to as a second cache registration processing) is performed with respect to the data (write data) assigned by the write request transmitted by the client device 40 (step S23).

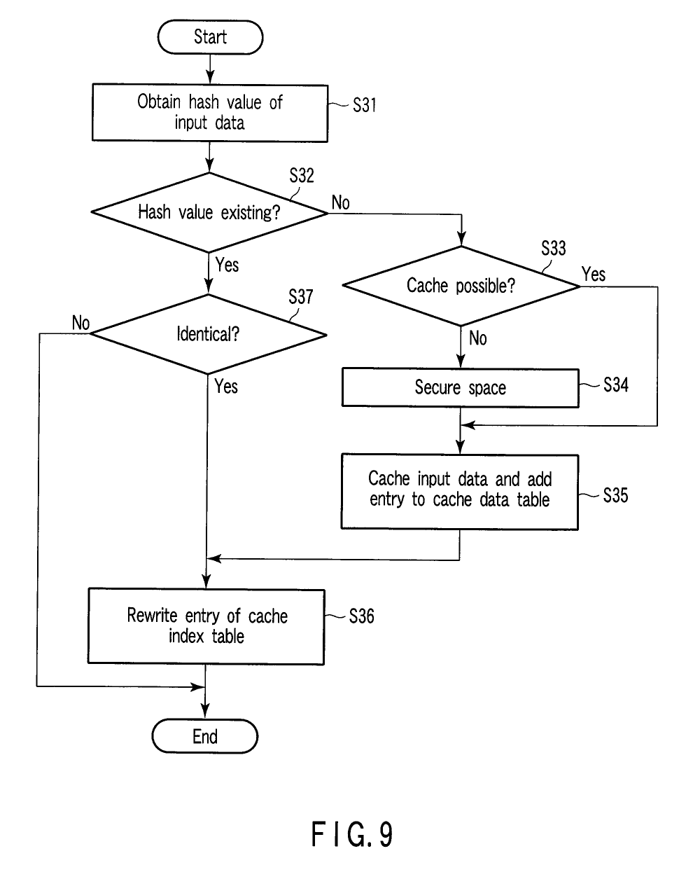

Here, with reference to the flow chart of FIG. 9, the processing procedure of the cache registration processes of step 16 indicated in FIG. 7 and of step S23 indicated in FIG. 8 will be explained.

As mentioned above, the timing of performing the cache registration processing is different depending on the type of request (read request or write request) transmitted by the client device 40. However, the above mentioned first cache registration processing and second cache registration processing are performed when the disk volume serial number, LBA and data (read data or write data) are input by (the relay unit 31 of) the relay device 30. Therefore, the processing carried out in the first cache registration processing and the second cache registration processing is considered identical. Accordingly, the processing will be considered as identical and explained as follows.

The disk volume serial number and the LBA are indexes included in, for example, the read request or the write request. Further, the data input by the relay device 30 will be explained as target data.

The relay unit 31 passes the input disk volume serial number, the LBA and the target data over to the cache management unit 32. The cache management unit 32 transmits the received target data to the identifier generating unit 33.

The identifier generating unit 33 generates an identifier which corresponds to the contents of the target data transmitted by the cache management unit 32. At this time, the identifier generating unit 33 generates a hash value as the identifier. This hash value is generated by using, for example, a predetermined hash function, such as SHA1.

The cache management unit 32 obtains the hash value generated by the identifier generating unit 33 (step S31).

The cache management unit 32 determines whether or not the obtained hash value exists in the cache data table 23 (step S32).

In the case where the obtained hash value is determined as not existing in the cache data table 23 (NO in step S32), the cache management unit 32 determines whether or not there is a space area to store (cache) the target data in, for example, the cache database 22, i.e., whether or not the memory area of the cache database 22 is exhausted (step S33).

In the case where it is determined that there is no space area for caching (NO in step S33), the cache management unit 32 secures a space area for caching the target data in the cache database 22. At this time, the cache management unit 32 eliminates, for example, the least necessary data among the cache data cached in the cache database 22, from the cache data base 22. Here, the least necessary data is distinguished in consideration of, for example, time/space locality. For example, LRU (Least Recent Used) etc. may be applied.

Further, the cache management unit 32 deletes the address of the cache data stored in the secured area and the identifier (hash value) corresponding to the contents of the cache data from the cache data table 23 and unregisters the identifier in the cache data table 23.

After the space area to cache the target data in the cache database 22 is secured, the cache management unit 32 caches the target data in the secured area of the cache database 22 (step S35). Further, the cache management unit 32 adds (registers) the address in which the cached target data is stored and the identifier (entry) which corresponds to the contents of the target data, to the cache data table 23 (step S35). Further, the identifier which corresponds to the contents of the target data is the hash value generated in the above mentioned step S31.

The cache management unit 32 then identifies the cache index table 24-i which corresponds to the disk volume identified by the disk volume serial number (the disk volume serial number “i”) passed over from the relay unit 31. In the identified cache index table 24-i, the cache management unit 32 rewrites the hash value associated with the LBA passed over from the relay unit 31 to the hash value obtained in the above mentioned step S31 (step S36).

Meanwhile, in the case where the hash value obtained in step S32 is determined as existing in the cache data table 23, the cache management unit 32 identifies the address registered in association with the obtained hash value in the cache data table 23. The cache management unit 32 determines whether or not the data (cache data) stored in the address identified in the cache database 22 and the target data are identical (step S37).

In the case where it is determined that the data stored in the address identified in the cache database 22 and the target data are identical (YES in step S37), the processing of step S36 is performed.

Meanwhile, in the case where it is determined in step S37 that the data stored in the address identified in the cache database 22 is not identical with the target data, a hash clash is detected due to identical hash values corresponding to a plurality of data. For example, in the case of detecting a hash clash, the cache registration processing for the target data is ended. In other words, the target data is not cached.

Further, it may also be configured so that when a hash clash is detected, a hash function which is different from the one used to generate the hash value up until then is used to generate a hash value. It may also be that an identifier which is different from the hash value is generated, and the different identifier is given as a second identifier. In this manner, for example, it is possible to perform the cache registration processing while avoiding the hash clash.

In addition, in the above mentioned cache registration processing, in the case where, for example, the request from the client device 40 to the storage device 50 is a write request, when the write request is for cache data which is already cached, the data is updated to the write data. When the write request is for data which is not cached, the write data is cached. However, it may also be configured so that when, for example, there is a write request for data which is not cached, instead of caching the data, the identifier (hash value) which is registered in the cache index table 24 in association with the disk volume serial number and LBA included in the write request is nullified. In this case, when the write data assigned by the write request is, for example, read out from the storage device 50, it is cached in the relay device 30.

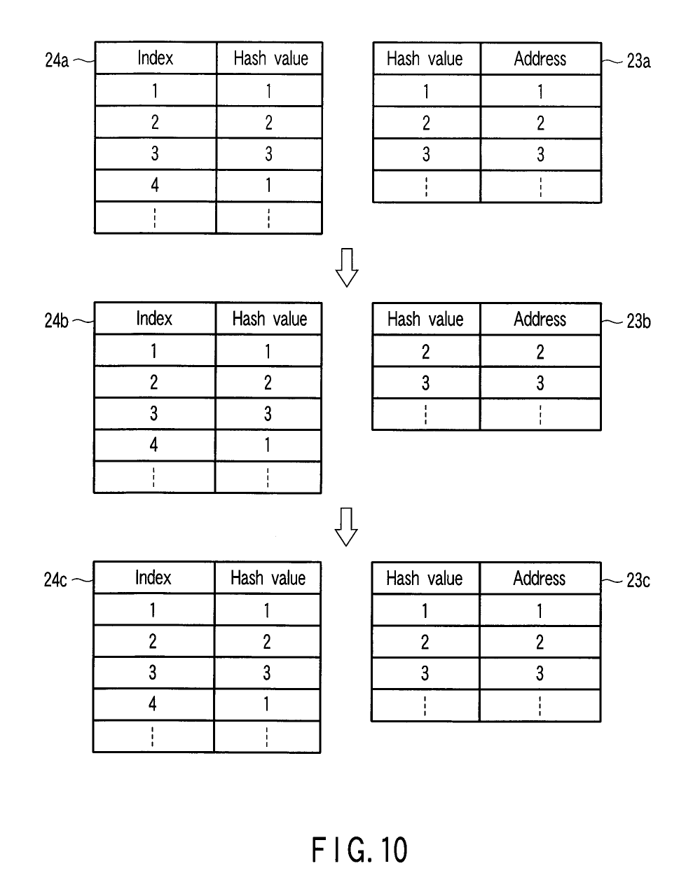

Now, with reference to FIG. 10, the operation of the present embodiment will be explained in detail. As shown in FIG. 10, first of all, hash value 1 is associated with index 1 and registered in a cache index table 24a. Similarly, suppose that hash value 2 is associated with index 2, hash value 3 is associated with index 3 and hash value 1 is associated with index 4 and registered. Meanwhile, an address 1 is associated with the hash value 1 and registered in a cache data table 23a. Similarly, suppose that address 2 is associated with hash value 2 and address 3 is associated with hash value 3 and registered. Further, suppose, for example, the data stored (cached) in the cache database 22 at address 1 is called data A.

In other words, data A which is stored in the cache database 22 at address 1 is the data indicated by indexes 1 and 4 registered in the cache index table 24a.

Here, suppose a case in which, for example, an area which stores data A (area indicated by address 1) is, for instance, secured as a space area when the memory area of the cache database 22 has exhausted. In this case, the hash value 1 and the address 1 registered in the cache data table 23a are eliminated from the cache data table 23a and become unregistered. Accordingly, as show in FIG. 10, the cache data table 23a is updated to a cache data table 23b.

In this manner, the data (data A) indicated by the above mentioned indexes 1 and 4 become uncached.

Meanwhile, even in the case where the hash value 1 and the address 1 which were registered in the cache data table 23a become unregistered, the indexes and hash values registered in the cache index table 24a do not become unregistered. Therefore, the cache index table 24a becomes the cache index table 24b (same as cache index table 24a).

Here, suppose the case in which, for example, a read request including index 1 is transmitted by the client device 40. Further, the data indicated by index 1 is data A. In this case, data A is cached in the cache database 22 by, for example, the cache registration processing as mentioned above. At this time, data A is considered as being cached in the cache database 22 at address 1.

In this case, hash value 1 which corresponds to the contents of data A and address 1 of the data A are associated and registered in the cache data table 23b. In other words, as shown in FIG. 10, the cache data table 23b becomes cache data table 23c.

In this manner, despite data A indicated by indexes 1 and 4 being uncached in the stage of the above mentioned cache data table 23b, when, for example, data A is re-cached in accordance with a read request including index 1, data A may also be cached for index 4.

Accordingly, in the case where there is a read request including, for example, index 4, even when a cache registration processing for index 4 is not preformed, a cache hit is determined and data can be transferred rapidly.

By managing the cache data table 23 and the cache index table 24 as mentioned above, when cache data pointed by a plurality of indexes is cached anew after being nullified, the present embodiment enables the plurality of indexes to point the re-cached data.

In other words, even in the case where the identifier (hash value) and address of data are unregistered from the cache data table 23, the entry (hash value) in the cache index table will not be unregistered. Accordingly, for example, when an entry which was once unregistered from the cache data table 23 is re-registered in the cache, entries of all cache index tables 24 which pointed the entry become valid. Therefore, negative effects caused by a cache mishit in the case where the cache data pointed by a plurality of indexes is nullified can be made small. Accordingly, data can be transferred effectively.

Further, in the present embodiment mentioned above, it is explained that the data (block volume) stored on the disk volume in the storage device 50 is cached in the relay device 30. However, the cache method with regard to the present embodiment mentioned above can also adopt a general cache besides the ones explained in the present embodiment. It is also fine to be configured so that, for example, the cache database 22, the cache data table 23 and the cache index table 24 are stored in, for instance, the memory of a computer 10.

Further, the present invention is not limited to the embodiment mentioned above in its entirety. In the implementation phase, it can be put into practice by modifying the components within the scope of its summary. Further, various inventions can be formed in an arbitrary combination of a plurality of components disclosed in the above mentioned embodiment. For example, it is fine to delete some components from the entire components indicated in the embodiment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of caching performed by a cache apparatus comprising a cache database used to cache data in a storage device, a cache data table and a cache index table, comprising:
inputting data stored in the storage device and an index indicating the data;
generating an identifier corresponding to contents of the input data;
determining whether or not a space area to cache the input data exits in the cache database;
caching the input data in the cache database when it is determined that the space area exists in the cache database;
registering the generated identifier in association with the cached data in the cache data table;
registering the generated identifier in association with the input index in the cache index table;
securing a space area in the cache database when it is determined that no space area exists in the cache database,;
caching the input data in the secured space area; and
unregistering the identifier registered in the cache data table which is in association with the input data which is cached in the secured space area.

2. The method according to claim 1, further comprising:
inputting a read request to request reading data from the storage device, the request including an index indicating the data which is to be requested to be read from the storage device;
identifying an identifier which is registered in the cache index table in association with the index included in the input read request;
determining whether or not data associated with the identified identifier in the cache data table exists in the cache database; and
outputting the data to the read requester in the case where it is determined that the data exists.

3. The method according to claim 1, further comprising:
determining whether or not the generated identifier is registered in the cache data table; wherein
in the step of determining whether or not the space area exits, in the case where the generated identifier is determined as unregistered in the cache data table, determining whether or not the space area exists in the cache database.

4. The method according to claim 1, further comprising:
in the case where the input data is write data to be written on the storage device, obtaining an identifier which is registered in the cache index table in association with an index indicating the data;
in reference to the cache data table, determining whether or not data associated with the obtained identifier exists; and
in the case where it is determined that the data exists, updating the data stored in the cache database to the write data.

5. The method according to claim 4, further comprising:
in the step of determining whether or not the data exists, in the case where the data is determined as nonexistent, nullifying the identifier which is registered in the cache index table in association with the index indicating the data.

6. The method according to claim 1, wherein
in the step of generating the identifier, generating a hash value as an identifier which corresponds to contents of the data, using a predetermined hash function.

7. The method according to claim 6, further comprising:
determining whether or not the generated hash value is registered in the cache data table;
in the case where it is determined that the hash value is registered in the cache data table, determining whether or not data associated with the generated hash value and the input data are identical; and
in the case where the foregoing is determined as nonidentical, detecting a hash clash, wherein
in the step of caching, in the case where the hash clash is detected, not caching the input data in the cache database.

8. The method according to claim 7, further comprising:
in the case where the hash clash is detected, generating a hash value using another hash function.

9. The method according to claim 7, further comprising:
in the case where the hash clash is detected, generating an identifier which is different from the hash value.

10. The method according to claim 1, wherein
the input data is transfer data which is transferred from the storage device to a client device, which are provided separately from the cache apparatus.

11. The method according to claim 10, wherein
the input data is a block volume stored in a disk volume provided in the storage device, and
the index includes an identification number which identifies the disk volume, and a logical block address in which the block volume is stored.

12. A cache apparatus comprising:
a cache database used for caching data;
an input unit configured to input data and an index indicating the data;
an identifier generating unit configured to generate an identifier corresponding to contents of the input data;
a determination unit configured to determine whether or not a space area to cache the input data exists in the cache database;
a cache database in which the input data is cached in the case where it is determined that the space area exists;
a cache data table in which the generated identifier is registered in association with the data cached in the cache database;
a cache index table in which the generated identifier is registered in association with the input index;
a securing unit configured to secure a space area in the cache database in the case where it is determined that the space area does not exist in the cache database;
a cache management unit configured to cache the input data in the secured space area; and
an unregister unit configured to unregister an identifier which is registered in the cache data table in association with data that was cached in the secured area.
